(19) United States
(12) Patent Application Publication
(10) Pub. No.: US 2009/0197071 A1
(43) Pub. Date: Aug. 6, 2009

(54) PREPARATION OF SUPERHYDROPHOBIC FIBROUS SUBSTRATES

(75) Inventors: Henri Cramail, Sainte-Terre (FR); Pierre Chambon, Sarlat-La-Caneda (FR); Eric Cloutet, Saint Caprais De Bordeaux (FR); Serge Ravaine, Cestas (FR)

Correspondence Address: YOUNG & THOMPSON, 209 Madison Street, Suite 500, ALEXANDRIA, VA, 22314, US

(73) Assignee: CENTRE NATIONAL DE LA RECHERCHE SCIENTIFIQUE (C.N.R.S.), PARIS (FR)

(21) Appl. No.: 12/095,743

(22) PCT Filed: Nov. 29, 2006
(86) PCT No.: PCT/FR2006/002615

§ 371 Date: Jan. 5, 2009

(30) Foreign Application Priority Data
Dec. 1, 2005 (FR) 0512199

(51) Int. Cl. B32B 5/16; B32B 3/26; B05D 3/02

(52) U.S. Cl. 428/315.5; 428/327; 427/389.9

(57) ABSTRACT

Process for the production of a superhydrophobic fibrous substrate. The process involves preparing hydrophobic core-shell microparticles, the microparticles having a core of polyurethane and a shell of polydimethylsiloxane or of polybutadiene, then depositing a liquid suspension of the microparticles on the fibrous substrate. Superhydrophobic fibrous substrates of this kind are useful for the manufacture of textiles intended for apparel, or of coatings for printing.

The present invention relates to a method for preparing superhydrophobic fibrous substrates, superhydrophobic fibrous substrates and the use of such substrates.

A material is considered to be superhydrophobic when the contact angle of a droplet of water deposited on the surface thereof is greater than 140 degrees.

Such materials have advantageous properties in a very wide range of fields, in particular clothing, stationery or paints.

In the field of clothing or stationery, the materials which it is desirable to render superhydrophobic generally have a fibrous nature.

In order to produce superhydrophobic fibrous materials, methods are known, in particular from WO 04/058419, EP 0 985 740 and EP 0 985 741, which use anchored fluorine-containing compounds. However, the materials obtained using these methods have a number of disadvantages. First of all, the chemical anchoring of the fluorine-containing organic agents has a low level of resistance with respect to repeated mechanical actions (wiping, washing) which are inherent to the use of the materials, in particular in the case of textiles. Furthermore, the degradation of the materials over time brings about the release of agents which pollute the environment.

Other methods are also known for producing superhydrophobic materials, in particular WO 04/090065 and WO 04/033788 which do not involve the chemical bonding of fluorine-containing compounds. However, the implementation of all these methods is complex.

The inventors have found that, surprisingly, it is possible to obtain superhydrophobic materials simply by depositing hydrophobic particles which have a specific chemical nature and structure on a fibrous substrate.

Furthermore, the superhydrophobic nature of the materials obtained is not susceptible to ageing, over a period of several months, when they are left to rest.

In this manner, according to a first aspect, the invention proposes a method for preparing a superhydrophobic fibrous substrate involving the following successive steps:
preparing hydrophobic microparticles of the core/shell type, the microparticles having a core of polyurethane and a shell of polydimethylsiloxane or polybutadiene;
depositing, on the fibrous substrate, a liquid suspension of said microparticies in an organic solvent.

The term fibrous substrate is intended to refer to any material which is constituted by synthetic or natural fibres.

The term microparticle is intended to refer to particles of a micrometer scale.

Other hydrophobic microparticles of the core/shell type which have a core of polyurethane and a shell which is formed by a polystyrene-poly(ethylene oxide) co-polymer, a hydroxypolystyrene, or poly(butylacrylate) were synthesised by the inventors, as described in the following publications: B. Radhakrishnan et al., Colloid Polym Sci (2002), 280, 1122-1130, and B. Radhakrishnan et al., Colloid Polym Sci (2003), 281, 516-530. However, these particles, once deposited on fibrous substrates, did not confer a superhydrophobic character on the substrates. In this manner, the specific selection of the microparticles used in the method according to the invention brings about the superhydrophobic properties conferred on the fibrous substrates.

The first step of the method according to the invention preferably involves a method for multistep polymerisation, in a medium which is dispersed in an organic solvent, of a first monomer which is constituted by a diol, for example, ethane-1,2-diol, and a second monomer of the diisocyanate type, for example, tolylene diisocyanate, in the presence of polydimethylsiloxane (PDMS) or polybutadiene which acts as a reactive stabilising agent. This method is described in detail by P. Chambon et al., Polymer (2005), 46, 1057-1066.

The organic solvent used for the preparation of microparticles may be cyclohexane or supercritical carbon dioxide.

The microparticles obtained have a diameter generally from 0.5 to 5 micrometres.

The size of the particles is adjusted by varying different parameters: the mass percentage of the reactive stabilising agent, the stirring rate, the speed and the sequence in which the monomers are added, the molar mass of the reactive stabilising agent and the functionality of the reactive stabilising agent.

According to a first embodiment, the fibrous substrate which it is desirable to render superhydrophobic, referred to below as the substrate to be processed, is constituted by natural fibres which are selected from the group comprising cellulose, wool, cotton, silk and may be filter paper.

According to another embodiment, the substrate to be processed is constituted by synthetic fibres which are selected from the group comprising polyamides and polyesters and it may have a porosity of between 1 and 10 micrometres. According to a preferred embodiment, the substrate is a cloth of polyamide.

A number of methods for depositing microparticles on the fibrous substrate lead to a superhydrophobic substrate being obtained. Depositing can be carried out, for example, by filtering the suspension of microparticles through the fibrous substrate, or by immersing the fibrous substrate in the suspension of microparticles, then evaporating the solvent, or by depositing the suspension on the fibrous substrate then evaporating the solvent.

According to a second aspect, the invention relates to a superhydrophobic fibrous substrate in which the fibres are impregnated with microparticles of the core/shell type, the microparticles having a core of polyurethane and a shell of polydimethylsiloxane or polybutadiene.

The microparticles have a diameter generally from 0.5 to 5 micrometres.

The substrate is, for example, constituted by a polyamide cloth or filter paper. Depending on the nature thereof, it may be used for the production of textiles which are intended for clothing, or for producing coatings for the printing industry.

The present invention is illustrated below by means of specific examples, but is not limited thereto. Example 1 relates to the preparation of hydrophobic microparticles and the following examples relate to the depositing of microparticles on different substrates.

### EXAMPLE 1

Particles of polyurethane having a core/shell structure are prepared using a method of dispersion in cyclohexane, in the presence of polydimethylsiloxane.

To this end, the reactive stabilising agent PDMS-OH, having a molar mass of 4670 g.mol⁻¹ (0.5 g, or 16.7% by mass), the monomer ethane-1,2-diol (0.6 g) and the cyclohexane (20 g) are introduced into the reactor then left at 60° C. under stirring for a few minutes. The co-monomer tolylene diisocyanate (1.9 g) is then added and the reaction medium is stirred at least 6 hours.

At the end of the reaction, the latex obtained is recovered, centrifuged, then the particles are again dispersed in cyclohexane This operation is repeated twice.

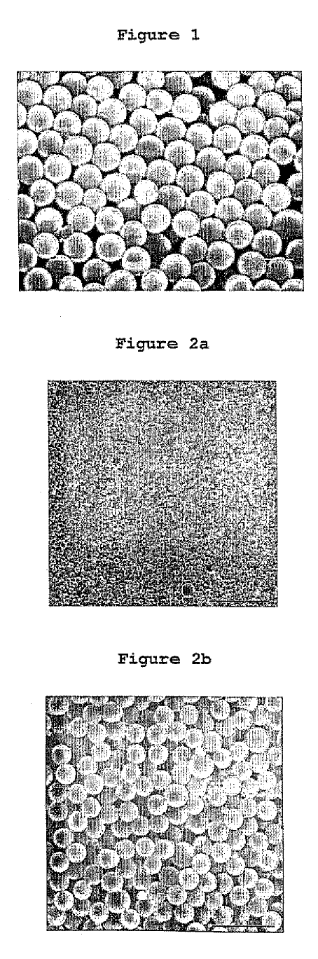

The particles obtained are characterised by means of scanning electron microscopy (SEM). FIG. 1 illustrates an SEM image of these particles whose diameter is equal to 2.2 μm.

The method was reproduced in order to obtain particles having a diameter of 3.5 and 4.2 μm, respectively, using a mass percentage of polydimethylsiloxane of 9% and 4%, respectively.

### EXAMPLE 2

### Implementation of the Method Using a Substrate which is Constituted by a Cloth of Polyamide

A solution containing 1% by mass of microparticles in cyclohexane, prepared according to the operating method of example 1, is filtered using a water pump, over a cloth of polyamide of 10 cm². The test was reproduced successively with polyamide cloths having a porosity of 1 μm, 5 μm and 10 μm, respectively, and with microparticles having a diameter of 2.2 μm, 3.5 μm and 4.2 μm.

In each of the tests, the surface of the cloth is then characterised by means of scanning electron microscopy. It was found that a homogeneous deposit which complies with the surface topology of the cloth of polyamide is obtained.

FIGS. 2a and 2b illustrate images obtained at two different scales, the side of the square formed by an image representing 147 micrometres and 37 micrometres, respectively, for the cloth having a porosity of 1 μm processed with a suspension of particles which have a diameter of 2.2 μm.

### EXAMPLE 3

### Implementation of the Method Using a Substrate which is Constituted by Filter Paper

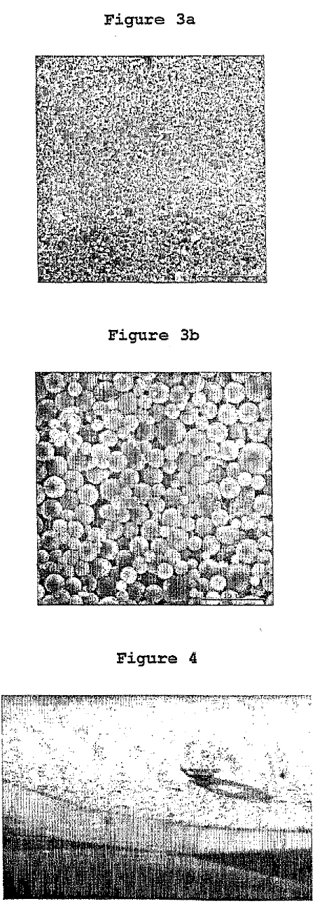

A method similar to that of example 2 was implemented using a filter paper in place of a polyamide cloth. Tests were carried out with particles having a diameter of 2.2 μm, 3.5 μm and 4.2 μm. A homogeneous deposit which complies with the surface topology of the filter paper is obtained, as illustrated in FIGS. 3a and 3b which illustrate scanning electron microscopy images obtained at different scales, the side of the square formed by an image representing 147 micrometres and 37 micrometres, respectively, for the filter paper processed using a suspension of particles having a diameter of 3.5 μm.

### EXAMPLE 4

The contact angle of a water droplet deposited on the surface of the processed substrates obtained in examples 2 and 3 was measured using a goniometer. The results are set out in Table 1 below.

By way of comparison, the deposit of different types of particle was also carried out on a glass plate.

TABLE 1

| | | Polyamide | Polyamide | Polyamide | |
|---|---|---|---|---|---|
| | | cloth | cloth | cloth | |
| | Glass | (porosity | (porosity | (porosity | Filter |
| | plate | 1 μm) | 5 μm) | 10 μm) | paper |
| Particles | 133° | 141° | 149° | 153° | 143° |
| of PU-PDMS | | | | | |
| (diameter | | | | | |
| 2.2 μm) | | | | | |
| Particles | 125° | 150° | 159° | 160° | 150° |
| of PU-PDMS | | | | | |
| (diameter | | | | | |
| 3.5 μm) | | | | | |
| Particles | — | 146° | 150° | 160° | 143° |
| of PU-PDMS | | | | | |
| (diameter | | | | | |
| 4.2 μm) | | | | | |

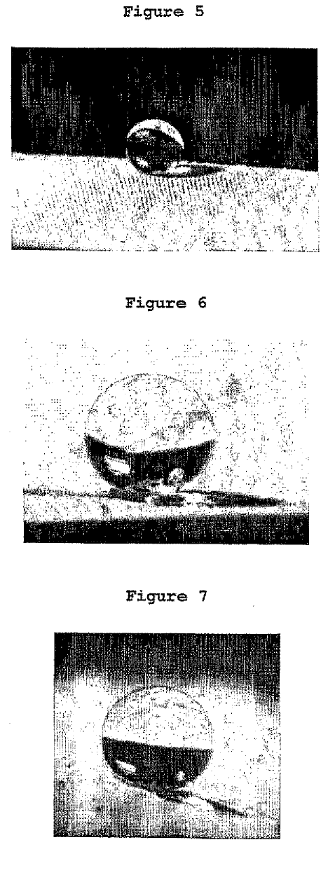

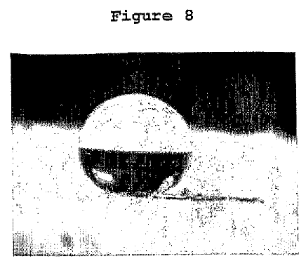

FIGS. 4 to 8 are optical microscopy images illustrating a droplet of water deposited on the following substrates, respectively:
FIG. 4: polyamide cloth having a porosity of 5 μm and particles having a diameter of 2.2 μm;
FIG. 5: polyamide cloth having a porosity of 1 μm and particles having a diameter of 2.2 μm;
FIG. 6: polyamide cloth having a porosity of 1 μm and particles having a diameter of 4.2 μm;
FIG. 7: filter paper and particles having a diameter of 2.2 μm;
FIG. 8: filter paper and particles having a diameter of 3.5 μm.

According to these results, it appears that the fibrous substrates on which the method according to the invention is implemented acquire superhydrophobic properties (angle of contact with a water droplet greater than 140°), in contrast to a non-fibrous substrate such as a glass plate.

1-19. (canceled)

20. Method for preparing a superhydrophobic fibrous substrate, characterised in that it comprises the following successive steps:
preparing hydrophobic microparticles of the core/shell type, said microparticles having a core of polyurethane and a shell of polydimethylsiloxane or polybutadiene;
depositing a liquid suspension of said microparticles on the fibrous substrate.

21. Method according to claim 20, characterised in that the step of preparing the hydrophobic microparticles is carried out by means of a multistep polymerisation, in a medium which is dispersed in an organic solvent, of a first monomer which is constituted by a diol and a second monomer of the diisocyanate type in the presence of polydimethylsiloxane or polybutadiene.

22. Method according to claim 21, characterised in that the first monomer is ethane-1,2-diol, and the second monomer is tolylene diisocyanate.

23. Method according to claim 21, characterised in that the organic solvent is selected from cyclohexane and supercritical carbon dioxide.

24. Method according to claim 22, characterised in that the organic solvent is selected from cyclohexane and supercritical carbon dioxide.

25. Method according to claim 20, characterised in that the microparticles have a diameter from 0.5 to 5 micrometres.

26. Method according to claim 20, characterized in that the fibrous substrate is constituted by natural fibres which are selected from the group comprising cellulose, wool, cotton and silk.

27. Method according to claim 26, characterised in that the fibrous substrate is filter paper.

28. Method according to claim 20, characterised in that the fibrous substrate is constituted by synthetic fibres which are selected from the group comprising polyamides and polyesters.

29. Method according to claim 28, characterised in that the fibrous substrate has a porosity from 1 to 10 micrometres.

30. Method according to claim 28, characterised in that the fibrous substrate is a polyamide cloth.

31. Method according to claim 20, characterised in that depositing is carried out by filtering the suspension of microparticles through the fibrous substrate.

32. Method according to claim 20, characterised in that depositing is carried out by immersing the fibrous substrate in the suspension of microparticles, then evaporating the solvent.

33. Method according to claim 20, characterised in that depositing is carried out by depositing the suspension of microparticles on the fibrous substrate, then evaporating the solvent.

34. Superhydrophobic fibrous substrate, characterised in that the fibres of said substrate are impregnated with microparticles of the core/shell type, said microparticles having a core of polyurethane and a shell of polydimethylsiloxane or polybutadiene.

35. Substrate according to claim 34, characterised in that the microparticles have a diameter from 0.5 to 5 micrometres.

36. Substrate according to claim 34, characterised in that it is constituted by a cloth of polyamide.

37. Substrate according to claim 34, characterised in that it is constituted by filter paper.
